(19) United States
(12) Patent Application Publication
(10) Pub. No.: US 2024/0416874 A1
(43) Pub. Date: Dec. 19, 2024

(54) VEHICLE STAND

(71) Applicant: TOYOTA JIDOSHA KABUSHIKI KAISHA, Toyota-shi Aichi-ken (JP)

(72) Inventor: Mamoru SETOGUCHI, Toyota-shi (JP)

(73) Assignee: TOYOTA JIDOSHA KABUSHIKI KAISHA, Toyota-shi (JP)

(21) Appl. No.: 18/740,993

(22) Filed: Jun. 12, 2024

(30) Foreign Application Priority Data
Jun. 19, 2023 (JP) 2023-100240

(51) Int. Cl. B60S 9/18; B60S 5/06

(52) U.S. Cl. CPC B60S 9/18; B60S 5/06

(57) ABSTRACT

A vehicle stand includes: first, second, third, and fourth support portions which support respective wheels of a vehicle; a first stand part which includes the first support portion and the second support portion; and a second stand part which includes the third support portion and the fourth support portion. Further, in the first stand part, the first support portion or the second support portion is movable in the width direction of the vehicle, and in the second stand part, the third support portion and the fourth support portion are movable in the longitudinal direction of the vehicle and the third support portion or the fourth support portion is further movable in the width direction of the vehicle.

### CROSS-REFERENCE TO RELATED APPLICATION(S)

The present application claims priority to and incorporates by reference the entire contents of Japanese Patent Application No. 2023-100240 filed in Japan on Jun. 19, 2023.

### BACKGROUND

The present disclosure relates to a vehicle stand.

In the electric vehicle, there is a large battery for driving mounted under the floor. As a disclosure for replacing the battery mounted under the floor of such an electric vehicle, for example, there is an exchange station disclosed in Japanese Laid-open Patent Publication No. 2012-006591. Electric vehicles fed by conveyors to this replacement station are loaded with the right front and right rear wheels on a conveyor system on a sliding door. When the sliding door located below the electric vehicle opens in the width direction of the electric vehicle, the conveyor system slides and an opening appears above the service bay under the electric vehicle. The battery of the electric vehicle is lowered into the service bay from the opening, and a new battery is raised from the service bay through the opening and attached to the electric vehicle.

### SUMMARY

There is a need for providing a technology that makes it possible to perform work under the floor by securing space under the vehicle with a simple configuration.

According to an embodiment, a vehicle stand includes: a first support portion which supports a first wheel of a vehicle; a second support portion which supports a second wheel of the vehicle, the second wheel being separated from the first wheel in a width direction of the vehicle; a third support portion which supports a third wheel of the vehicle, the third wheel being separated from the first wheel in a longitudinal direction of the vehicle; a fourth support portion which supports a fourth wheel of the vehicle, the fourth wheel being separated from the third wheel in the width direction of the vehicle; a first stand part which includes the first support portion and the second support portion at a predetermined height of the first stand part; and a second stand part which is separated from the first stand part and includes the third support portion and the fourth support portion at the predetermined height of the second stand part. Further, in the first stand part, the first support portion or the second support portion is movable in the width direction of the vehicle, and in the second stand part, the third support portion and the fourth support portion are movable in the longitudinal direction of the vehicle and the third support portion or the fourth support portion is further movable in the width direction of the vehicle.

### BRIEF DESCRIPTION OF THE DRAWINGS

FIG. 1A is a plan view of a vehicle stand according to an embodiment;

FIG. 1B is a front view of a vehicle stand according to the embodiment.

FIG. 1C is a view of the vehicle stand in FIG. 1A when viewed from A-A;

FID. 1D is a view of the vehicle stand of FIG. 1A when viewed from B-B;

FIG. 2 is a side view of an electric vehicle;

FIG. 3 is a front view of a vehicle stand before the electric vehicle is placed;

FIG. 4A is a drawing explaining an operation of mounting an electric vehicle on a vehicle stand;

FIG. 4B is another drawing explaining an operation of mounting an electric vehicle on a vehicle stand.

FIG. 5A is a drawing illustrating a state of placing an electric vehicle on the vehicle stand;

FIG. 5B is a drawing illustrating a condition prior to placing the electric vehicle on the vehicle stand;

FIG. 6 is a drawing explaining a work of taking out a driving battery from the electric vehicle;

FIG. 7 is a front view of the vehicle stand according to a modified example;

FIG. 8A is a schematic drawing of a movable portion according to a modified example; and

FIG. 8B is a schematic drawing of the movable portion according to a modified example.

### DETAILED DESCRIPTION

In the disclosure of Japanese Laid-open Patent Publication No. 2012-006591, when the service bay is located underground, it is necessary to construct a service bay to the underground, which may make the system with a large-scale. Even if service lanes as shown in FIG. 3 of Japanese Laid-open Patent Publication No. 2012-006591 is a high-floor type, the space of the slope for moving the space and the vehicle in the vertical direction to the position of the high floor is required, which may make the system with a large-scale.

Hereinafter, embodiments of the present disclosure will be described in detail with reference to the accompanying drawings. Note that the present disclosure is not limited by the embodiments described below. Further, in the description of the drawings, the same or corresponding elements are appropriately denoted by the same reference numerals. In addition, it should be noted that the drawings are schematic and the relationship between the dimensions of each element, etc., may be different from the actual ones. In some cases, the drawings may contain parts in which the relationship or ratio of the dimensions is different from each other. An appropriate X-axis in the figure, illustrates the orthogonal coordinate system of the Y-axis, and axial, thereby explaining the direction. The Cartesian coordinate system with an X direction, a Y direction, and a Z direction may be indicated in figures, with which directions are explained. In the space defined by the Cartesian coordinate system, the direction in which the X, Y, and Z components increased may be referred to as +X, +Y, and +Z directions, respectively.

### EMBODIMENT

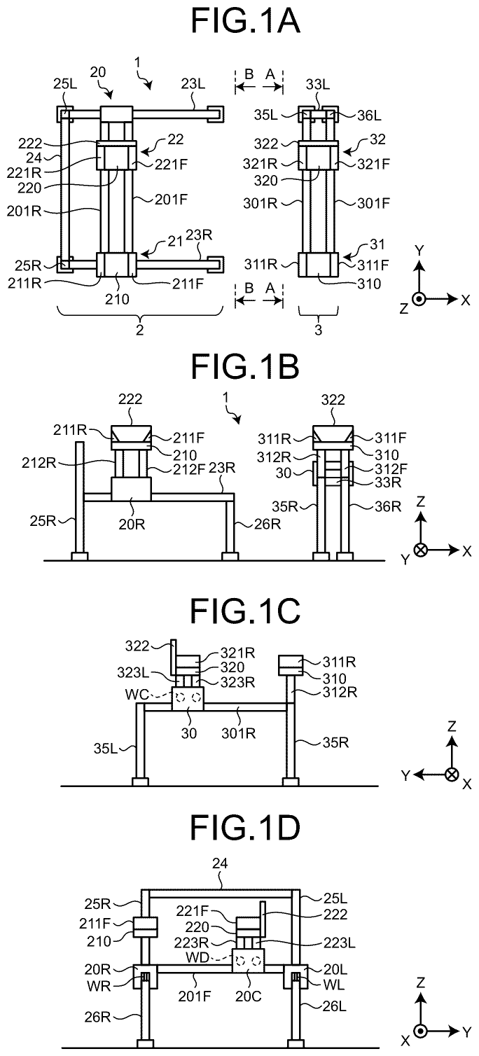

FIG. 1A is a plan view of a vehicle stand 1 according to an embodiment of the present disclosure, and FIG. 1B is a front view of the vehicle stand 1. Further, FIG. 1C is a drawing of the vehicle stand 1 of FIG. 1A viewed from the A-A arrow direction, and FIG. 1D is a drawing of the vehicle stand 1 of FIG. 1A viewed from the B-B arrow direction. The vehicle stand 1 made of metal is composed of a second stand part 2 and a first stand part 3 which is separated from the second stand part 2. The vehicle stand 1 is used in the operation of taking out the driving batteries for driving a Battery Electric Vehicle (BEV) from under the floor of the electric vehicle. Incidentally, the application of the vehicle stand 1 is not limited to the work of taking out the driving battery from the electric vehicle. For example, the vehicle stand 1, or a Hybrid Electric Vehicle (HEV), placing an electric vehicle such as a Plug-in Hybrid Electric Vehicle (PHEV), may be used in the task of taking out the secondary batteries from under the floor of the electric vehicle. Further, the vehicle stand 1, a Fuel Cell Electric Vehicle (FCEV) is mounted, a fuel cell mounted under the floor of the fuel cell vehicle, may be used in the operation of taking out from under the floor. Further, the vehicle stand 1, placing a vehicle driven by the engine, may be used for work under the floor.

The second stand part 2 has a pillar 25L, a pillar 25R, a pillar 26L, and a pillar 26R. The pillar 25L, the pillar 25R, the pillar 26L, and the pillar 26R may be a square column but H-shaped steel. The pillar 25L is in the +Y direction with respect to the pillar 25R, and the pillar 26R is in the +X direction with respect to the pillar 25R. Further, the pillar 26L is in the +Y direction with respect to the pillar 26R. The pillar 25R and the pillar 25L are the same length, and the pillar 26R and the pillar 26L are the same length. The length of the pillar 25R and the pillar 25L is longer than that of the pillar 26R and the pillar 26L.

The second stand part 2 includes a beam 23R, a beam 23L, and a beam 24. The beam 23R is a member that is passed from the pillar 25R to the pillar 26R along the X-axis direction, and the beam 23L is a member that is passed from the pillar 25L to the pillar 26L along the X-axis direction. The beam 23R and the beam 23L are an exemplary second beam according to the present disclosure.

Further, the second stand part 2 has a rear wheel support portion 20 movable in the +X direction and −X direction between the beam 23L and the beam 23R. The rear wheel support portion 20 includes a movable portion 20L, a movable portion 20R, a beam 201F, a beam 201R, a third support portion 21, and a fourth support portion 22. The movable portion 20L has a concave shape that sandwiches the beam 23L in the Y-axis direction to prevent it from falling off from the beam 23L, and has a wheel WL in contact with the upper surface of the beam 23L. The movable portion 20R has a concave shape to sandwich the beam 23R along the Y-axis to prevent it from falling off from the beam 23R, and has a wheel WR in contact with the upper surface of the beam 23R. The movable portion 20R and the movable portion 20L are an exemplary first movable portion according to the present disclosure. The beam 201F and the beam 201R are members passed from the movable portion 20L to the movable portion 20R along the Y-axis. The beam 201F and the beam 201R are examples of the third beam according to the present disclosure.

On the movable portion 20R, the third support portion 21 for supporting the right rear wheel which is an exemplary third wheel of an electric vehicle to be mounted on the vehicle stand 1 is provided. The third support portion 21 includes a support leg 212F, a support leg 212R, a bottom plate 210, the wheel retaining 211F, and a wheel stopper 211R. The support leg 212F is provided at the end in the +X direction on the upper surface of the movable portion 20R, the support leg 212R is provided at the end in −X direction on the upper surface of the movable portion 20R. The support leg 212F and the support leg 212R support a rectangular plate-like bottom plate 210. In the upper surface of the bottom plate 210, the wheel stopper 211F of the shape of a triangular prism is provided at the end of the +X direction, the wheel stopper 211R of the shape of a triangular prism is provided at the end of −X direction.

On the beam 201F and the beam 201R, the fourth support portion 22 for supporting the left rear wheel which is an exemplary fourth wheel of an electric vehicle to be mounted on the vehicle stand 1 is provided. The fourth support portion 22 includes a movable portion 20C, a support leg 223R, a support leg 223L, a bottom plate 220, a wheel stopper 221F, a wheel stopper 221R, and a side plate 222. The movable part 20C has a concave shape to sandwich the beam 201F and the beam 201R in the X-axis direction in order to prevent the beam 201F from falling off from the beam 201R, and has a wheel WD in contact with the upper surface of the beam 201F and a wheel WD in contact with the upper surface of the beam 201R. The movable portion 20C is an exemplary second movable portion according to the present disclosure. The support leg 223L is provided at the end in the +Y direction on the upper surface of the movable portion 20C, the support leg 223R is provided at the end in-Y direction on the upper surface of the movable portion 20C. The support leg 223L and the support leg 223R support a rectangular plate-like bottom plate 220. In the upper surface of the bottom plate 210, the wheel stopper 221F of the shape of a triangular prism is provided at the end of the +X direction, the wheel stopper 221R of the shape of a triangular prism is provided at the end of −X direction. The side plate 222 has a rectangular plate shape and is fixed to the bottom plate 220, the wheel stopper 221F, and the +Y direction-side end surface of the wheel stopper 221R. The +Z height of side plate 222 is greater than the height of the wheel stopper 221F and wheel stopper 221R.

The first stand part 3 has a pillar 35L, a pillar 35R, a pillar 36L, and a pillar 36R. The pillar 35L, the pillar 35R, the pillar 36L, and the pillar 36R may be a square column but H-shaped steel. The pillar 35L is in the +Y direction with respect to the pillar 35R, and the pillar 36R is in the +X direction with respect to the pillar 35R. Further, the pillar 36L is in the +Y direction with respect to the pillar 36R.

Also, the first stand part 3 has a beam 33R, a beam 33L, a beam 301F, and a beam 301R. The beam 33R is a member that is passed from the pillar 35R to the pillar 36R along the X-axis direction, and the beam 33L is a member that is passed from the pillar 35L to the pillar 36L along the X-axis direction. The beam 301F is a member that is passed from the pillar 36R to the pillar 36L along the Y-axis direction, and the beam 301R is a member that is passed from the pillar 35R to the pillar 35L along the Y-axis direction. The beam 301F and the beam 301R are examples of the first beam according to the present disclosure.

The first stand part 3 has a first support portion 31 for supporting the right front wheel which is an example of the first wheel of an electric vehicle which is mounted on the vehicle stand 1. The first support portion 31 includes a support leg 312F, a support leg 312R, a bottom plate 310, a wheel stopper 311F, and a wheel stopper 311R. The support leg 312F is provided over the pillar 36R and a support leg 312R is provided over the pillar 35R. The support leg 312F and the support leg 312R support a rectangular plate-like bottom plate 310. In the upper surface of the bottom plate 310, the wheel stopper 311F of the shape of a triangular prism is provided at the end of the +X direction, and the wheel stopper 311R of the shape of a triangular prism is provided at the end of −X direction.

The first stand part 3 has a second support portion 32 for supporting the left front wheel is an example of a second wheel of an electric vehicle mounted on the vehicle stand 1. The second support portion 32 includes the movable portion 30, the support leg 323R, the support leg 323L, the bottom plate 320, the wheel stopper 321F, a wheel stopper 321R, and the side plate 322. The movable portion 30 is a concave shape sandwiching the beam 301F and the beam 301R in the X-axis to prevent falling off from the beam 301F and the beam 301R, and has a wheel WC in contact with the upper surface of the beam 301F and a wheel WC in contact with the upper surface of the beam. The support leg 323L is provided at an end portion in the +Y direction on the upper surface of the movable portion 30, and the support leg 323R is provided at an end portion in-Y direction on the upper surface of the movable portion 30. The support leg 323L and the support leg 323R support a rectangular plate-like bottom plate 320. In the upper surface of the bottom plate 320, the wheel stopper 321F of the shape of a triangular prism is provided at the end of the +X direction, and the wheel stopper 321R of the shape of a triangular prism is provided at the end of −X direction. The side plate 322 has a rectangular plate shape and is fixed to the +Y direction-side end surface of the bottom plate 320, the wheel stopper 321F, and the wheel stopper 321R. The +Z height of side plate 322 is greater than the height of the wheel stopper 321F and wheel stopper 321R.

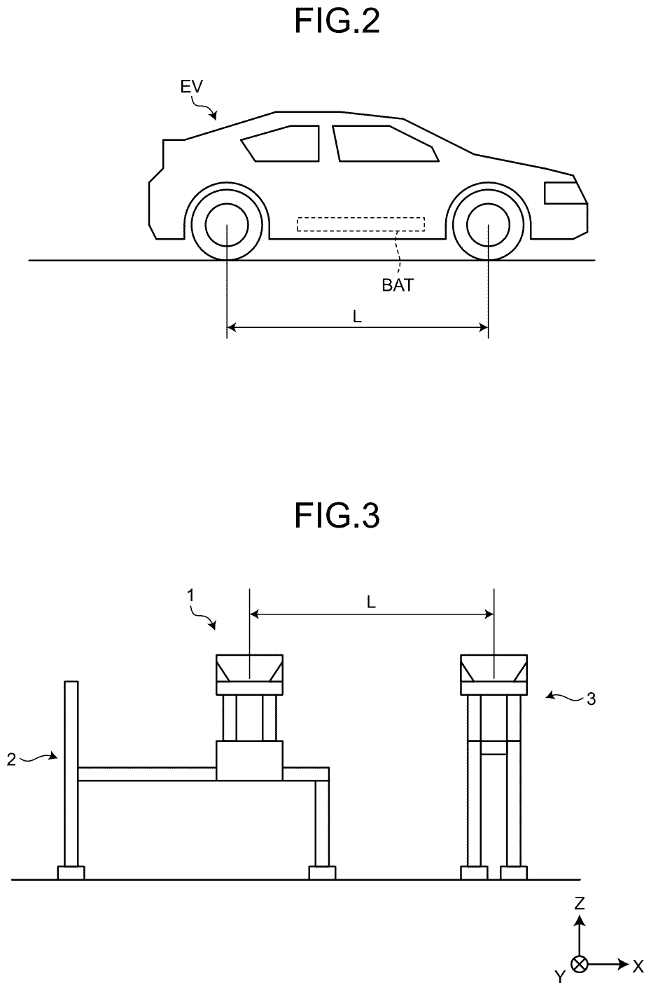

FIG. 2 is a side view of an electric vehicle (EV). The Electric vehicle (EV) has a driving cell BAT under the floor as a power source for the motor for driving the wheels. In the following explanation, the wheelbase of the electric vehicle EV is referred to as L, and the tread-width is referred to as W.

FIG. 3 is a front view of a vehicle stand 1 before an electric vehicle EV is mounted. An operator, who removes the driving battery BAT from the electric vehicle EV, first mover the rear wheel support portion 20 in the X-axis so as to set the distance between the first support portion 31 and the third support portion 21 and the distance between the second support portion 32 and the fourth support portion 22 to be equal to L which is the wheel base of the electric vehicle (EV). Since the rear wheel support portion 20 is movable in the X axis direction with the wheel WR of the movable portion 20R and the wheel WL of the movable portion 20L, it is easy for the operator to adjust the distance between the first support portion 31 and the third support portion 21 and the distance between the second support portion 32 and the fourth support portion 22.

Further, the operator sets the distance between the first support portion 31 and the second support portion 32 to be less than W of the tread width, the distance between the third support portion 21 and the fourth support portion 22 to be less than W of the tread width.

Here, the second support portion 32 is movable in the Y-axis direction by the wheel WC of the movable portion 30, and the fourth support portion 22 is movable in the Y-axis direction by the wheel WD of the movable portion 20C. Therefore, it is easy for the operator to adjust the distance between the first support portion 31 and the second support portion 32 and the distance between the third support portion 21 and the fourth support portion 22.

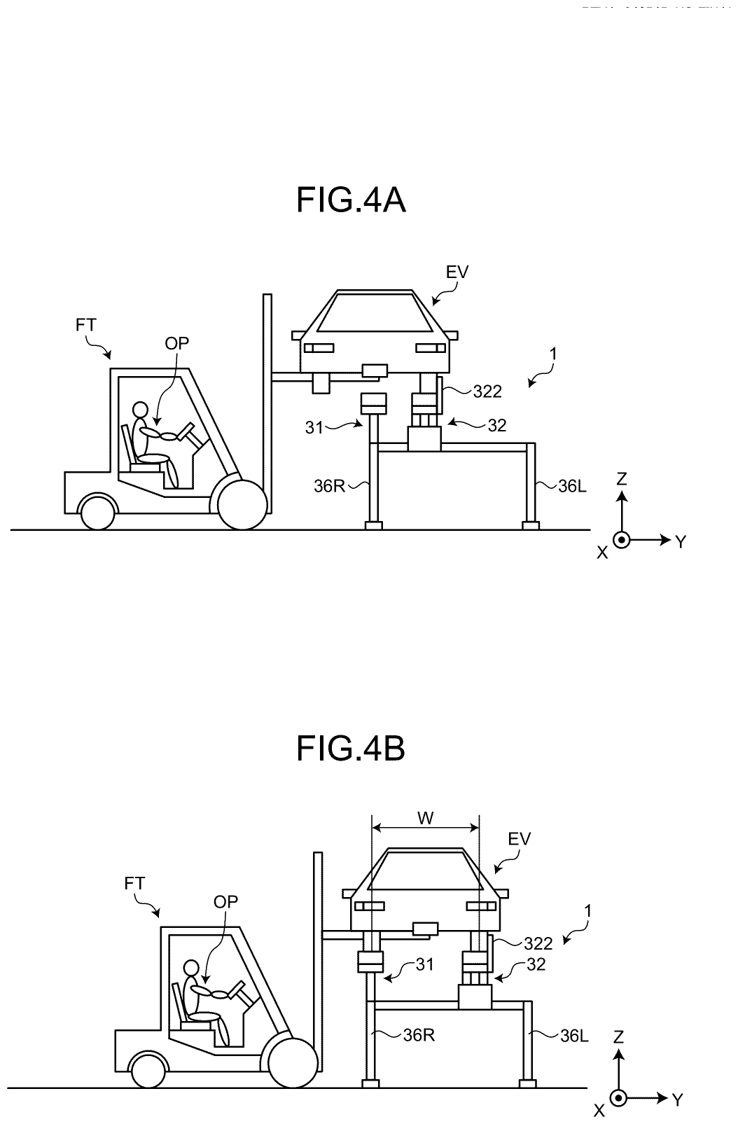

FIG. 4A and FIG. 4B are drawings explaining an operation of placing an electric vehicle EV on a vehicle stand 1. The operator OP places the electric vehicle EV on the fork of the forklift FT as illustrated in FIG. 4A, pushes the left side surface of the left front wheel against the side plate 322, and pushes the left side surface of the left rear wheel against the side plate 222 to move the electric self-powered vehicle EV in the +Y direction. The left side surface of the left front wheel is pressed against the side plate 322, since the left side surface of the left rear wheel is pressed against the side plate 222, as illustrated in FIG. 4B, the second support portion 32 by the movable portion 30 is moved in the +Y direction, the fourth support portion 22 by the movable portion 20C is moved in the +Y direction.

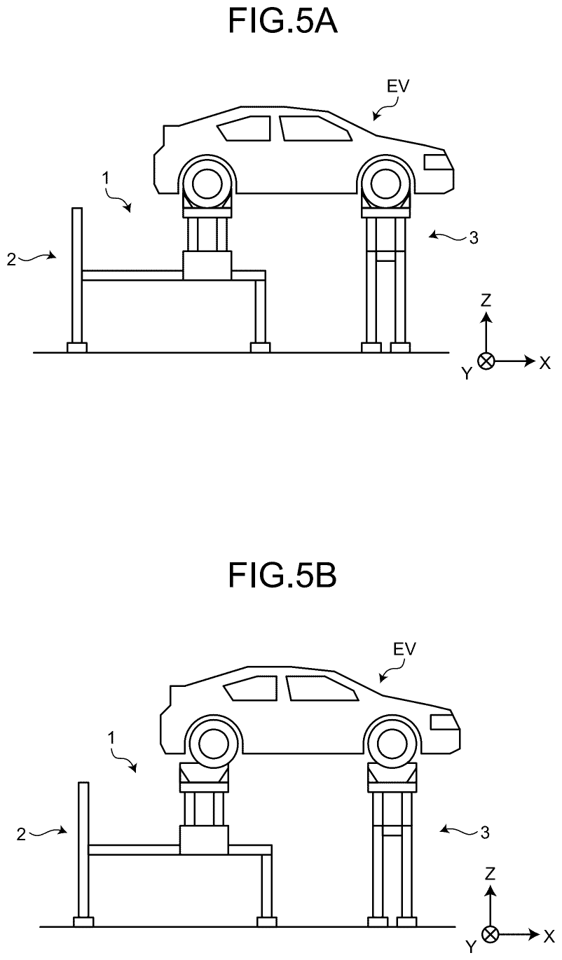

FIG. 5A is a drawing illustrating a state in which a vehicle EV is on the vehicle stand 1. The operator OP, when the right front wheel is positioned on the first support portion 31 and the right rear wheel is positioned on the third support portion 21 as illustrated in FIG. 4B, lowers the fork of the forklift FT, places the right front wheel on the first support portion 31, places the left front wheel on the second support portion 32, places the right rear wheel on the third support portion 21, and places the left rear wheel on the fourth support portion 22. Since each wheel of the electric self-powered vehicle EV mounted on the vehicular mount 1 is located between the wheel stoppers of each supporting portion, the moving to the front and rear is suppressed.

FIG. 5B is a drawing illustrating a state immediately before placing the electric vehicle EV on the vehicle stand 1. As illustrated in FIG. 5B, even if the distance between the first support portion 31 and the third support portion 21, and the distance between the second support portion 32 and the fourth support portion 22 are longer than L which is the wheel base, the right rear wheel of the electric self-powered vehicle EV when lowering the fork of the forklift FT comes into contact with the wheel stopper 211F, and the left rear wheel comes into contact with the wheel stopper 221F, since the movable portion 20L and the movable portion 20R moves in the +X direction, the distance between the first support portion 31 and the third support portion 21, and the distance between the second support portion 32 and the fourth support portion 22 can be aligned with L which is the wheel base of the electric vehicle EV.

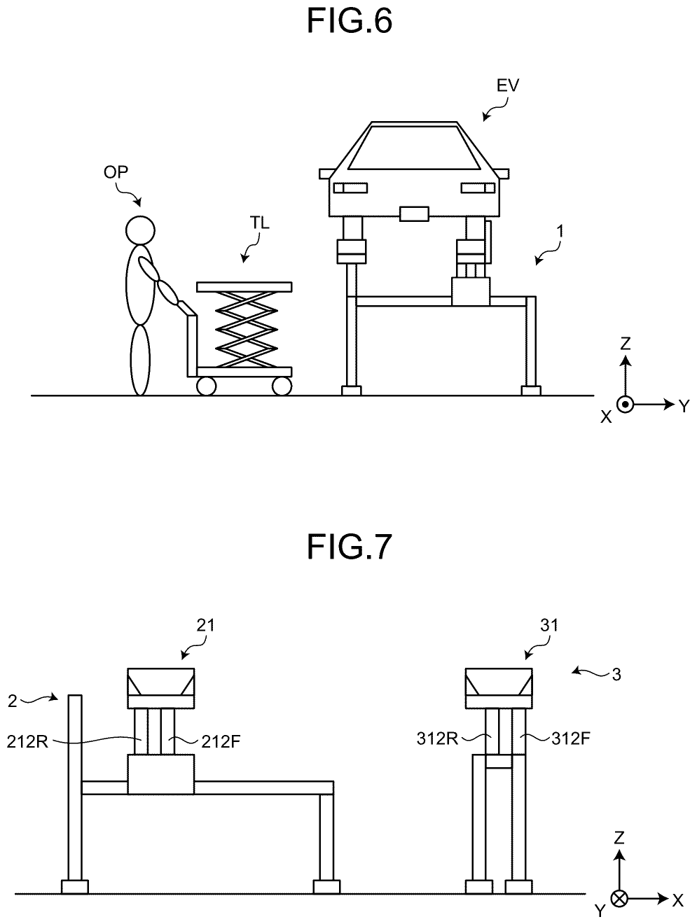

FIG. 6 is a drawing explaining an operation of taking out a driving battery BAT from an electric vehicle EV. The operator OP places a table-lift TL underneath the electric vehicle EV for mounting the driving cell BAT from between the first stand part 3 and the second stand part 2. The operator OP places the driving battery EV taken out from under the floor of the electric vehicle EV on the table lift TL and carries out the driving battery EV from between the first stand part 3 and the second stand part 2.

Here, the part of the rocker panel of the electric vehicle EV is not supported, but the wheels are supported. Therefore, the driving battery BAT taken out from under the floor does not interfere with the portion supporting the electric vehicle EV, so that it is possible to easily take out the driving battery BAT. Further, with the vehicle stand 1, it is possible to adjust the position in the X-axis direction of the rear wheel support portion 20 in accordance with L of the wheel base, and further adjust the distance between the third support portion 21 and the fourth support portion 22 in accordance with W of the tread width, and the distance between the first support portion 31 and the second support portion 32. Therefore, it is possible to remove the driving battery BAT for various vehicle models from a small vehicle to a large vehicle. Further, with the vehicle stand 1, the distance between the third support portion 21 and the fourth support portion 22 and the distance between the first support portion 31 and the second support portion 32 can be adjusted separately. Therefore, it is possible to support an electric vehicle (EV) even if the tread width in the front wheels differs from that in the rear wheels. Further, in the vehicle stand 1, the first stand part 3 for supporting the front wheels is separated from the second stand part 2 for supporting the rear wheels. Therefore, when the operator OP or the table lift TL is moved below the electric vehicle EV, there is no obstacles which hinders the movement on the moving line of the operator OP and table lift TL. Therefore, it is possible to perform operations efficiently. Further, in the present embodiment, each movable portion sandwiches the beam. Therefore, it is possible to prevent from falling off from the beam. Incidentally, even when the vehicle to be mounted on the vehicle stand 1 is a hybrid vehicle or a plug-in hybrid vehicle, it is still possible to remove the parts from under the floor by placing various vehicle types. Further, when the vehicle to be mounted on the vehicle stand 1 is an engine vehicle, it is still possible to perform operations under the floor by placing various vehicle types.

### Modification

While embodiments of the present disclosure have been described above, the present disclosure is not limited to the above-described embodiments and can be implemented in various other forms. For example, the above embodiment may be modified as follows to implement the present disclosure. Incidentally, the embodiments described above and the following modifications may also be combined each other.

It is also included in the present disclosure that the components of each of the above-described embodiments and each modification are appropriately combined and configured. Further effects and variations can also be readily derived by those skilled in the art. Therefore, a broader aspect of the present disclosure is not limited to the above embodiments and modifications, and various modifications can be made.

FIG. 7 is a front view of a vehicle stand according to a modification of the present disclosure. In the present disclosure, the position of the support leg 212F and a position shifted from the position illustrated in FIG. 1B in −X direction, the position of the support leg 312R may be a position shifted from the position illustrated in FIG. 1B in the +X direction. In this modification, even if L of the wheelbase is the same, since the distance from the support leg 212F to the support leg 312R is increased, it is possible to secure a wide space below the electric vehicle EV.

In the present disclosure, the fourth support portion 22 does not include a side plate 222, the second support portion 32 may be configured not include a side plate 322. In this configuration, when placing the electric vehicle EV on the vehicle stand 1, the distance between the first support portion 31 and the second support portion 32 is adjusted in advance in accordance with W of the tread width of the electric vehicle, and the distance between the third support portion 21 and the fourth support portion 22 is also adjusted.

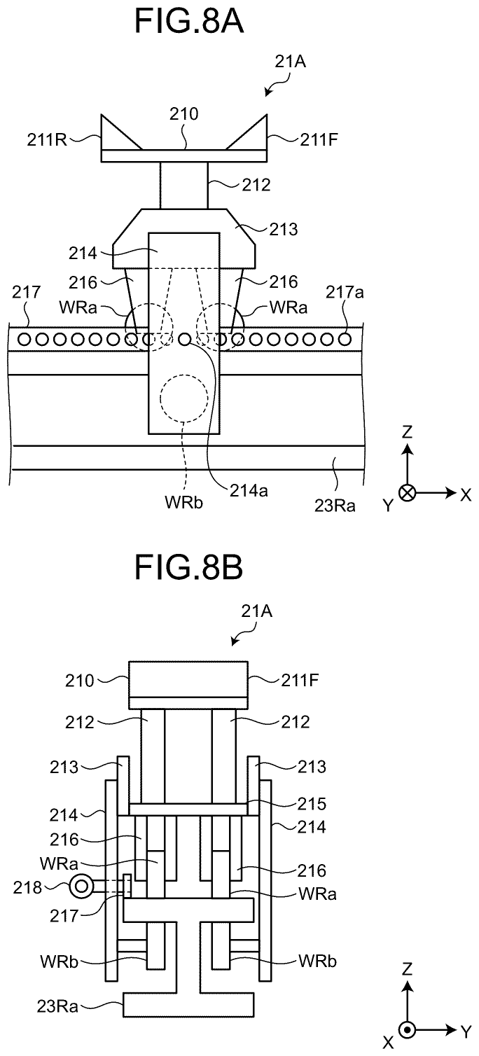

FIG. 8A and FIG. 8B are schematic views of a third support portion 21A according to a modification of the present disclosure. The beam 23Ra is H-shaped steel and is a member which is passed from 25R of support to 26R of support along the X-axis instead of beam 23R. On the end portion in-Y direction at the upper surface of the beam 23Ra, the fixing plate 217 which is a strip-shaped plate material formed of a metal is fixed along the X-axis direction. On the fixing plate 217, a through hole 217a penetrating in the Y-axis direction is formed with a plurality along the X-axis direction. The support leg 212 is a member for supporting the bottom plate 210 and is fixed to the base portion 215. The base portion 215 is a rectangular plate-shaped member, a plate-shaped and trapezoidal side plate 213 is fixed at the ends of the +Y direction and the −Y direction. Below the base portion 215, a wheel support 216 for supporting the wheel WRa is fixed. A rectangular plate-shaped side plate 214 is fixed to the side plate 213. The side plate 214 supports a wheel WRb. The third supporting portion 21A sandwiches the beam 23Ra from the +Z direction and −Y direction by the wheel WRa and the wheel Wrb, and is movable in the X-axis direction. According to this configuration, since the beam 23R is sandwiched vertically by the wheel WRa and the wheel WRb, and the beam 23Ra is sandwiched in the Y-axis direction by the side plate 214, it is possible to prevent the third support portion 21A from falling off from the beam 23Ra. Further, in the side plate 214, a through hole 214a penetrating in the Y-axis direction is formed. A pin 218 in the form of an eyebolt has a rod-shaped portion, which is inserted from −Y direction into the through hole 214a and the through hole 217a. After the right rear wheel of the electric vehicle EV rests on the third support portion 21A, the operator inserts the pin 218 from −Y direction side into both the through-hole 214a and the through-hole 217a. When the pin 218 is inserted into both the through-hole 214a and the through-hole 217a, even if a force in the X-axis direction acts on the third support portion 21A since the pin 218 is applied to the fixing plate 217, the rear wheel support portion 20, the fourth support portion 22, and the third support portion 21A can be prevented from moving in the X-axis direction. Note that with respect to the other fourth support portion 22, and the second support portion 32, the same configuration as the third support portion 21A is applied, so that a corresponding fixing plate 217 can be provided to the beam, and it may be prevented from moving in the Y-axis direction with the pin 218.

In the present disclosure, the fourth support portion 22 may be fixed on the movable portion 20L, the third support portion 21 may be movable in the Y-axis direction, the second support portion 32 may be fixed on the beam 33L, and the first support portion 31 may be movable in the Y-axis direction. In this modification, in this case, the electric vehicle EV is carried by the forklift FT from the +Y axis direction toward-Y axis direction and mounted on the vehicle stand 1.

Note that the front wheel may be placed on the second mount 2, and the rear wheel may be placed on the first mount 3. In this case, the fourth support portion 22 supports the right front wheel of the electric vehicle EV, the third support portion 21 supports the left front wheel of the electric vehicle EV, the second support portion 32 supports the right rear wheel of the electric vehicle EV, and the first support portion 31 supports the left rear wheel of the electric vehicle EV.

In the vehicle stand according to the present disclosure, an effect can be obtained, in which it is possible to perform an operation work under the floor to secure a space under the vehicle with a simple configuration.

According to an embodiment, it is possible to perform an operation under the floor by securing a space under the vehicle without a large-scale system.

According to an embodiment, it is possible to prevent the vehicle from falling from the first support portion, the second support portion, the third support portion, and the fourth support portion.

According to an embodiment, the first support portion or the second support portion to move prevents from falling off from the first stand part, the third support portion and the fourth support portion to move can be prevented from falling off from the second stand part.

According to an embodiment, the distance between the first support portion and the second support portion, and the distance between the third support portion and the fourth support portion can be adjusted to match the tread width of the vehicle.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle stand comprising:
a first support portion which supports a first wheel of a vehicle;
a second support portion which supports a second wheel of the vehicle, the second wheel being separated from the first wheel in a width direction of the vehicle;
a third support portion which supports a third wheel of the vehicle, the third wheel being separated from the first wheel in a longitudinal direction of the vehicle;
a fourth support portion which supports a fourth wheel of the vehicle, the fourth wheel being separated from the third wheel in the width direction of the vehicle;
a first stand part which includes the first support portion and the second support portion at a predetermined height of the first stand part; and
a second stand part which is separated from the first stand part and includes the third support portion and the fourth support portion at the predetermined height of the second stand part, wherein
in the first stand part, the first support portion or the second support portion is movable in the width direction of the vehicle, and
in the second stand part, the third support portion and the fourth support portion are movable in the longitudinal direction of the vehicle and the third support portion or the fourth support portion is further movable in the width direction of the vehicle.

2. The vehicle stand according to claim 1, wherein
the first support portion, the second support portion, the third support portion, and the fourth support portion are equipped with respective wheel stoppers of the vehicle.

3. The vehicle stand according to claim 1, wherein
the first stand part includes a first beam, which extends in the width direction,
the first support portion or the second support portion, which moves in the width direction, includes wheels to sandwich the first beam from above and below so as to move in the width direction along the first beam,
the second stand part includes a second beam, which extends in the longitudinal direction, and a first movable portion, which moves along the second beam,
the first movable portion includes wheels to sandwich the second beam from above and below so as to move in the longitudinal direction along the second beam,
the first movable portion includes a third beam, which extends in the width direction, and a second movable portion, which moves along the third beam, and
the second movable portion includes wheels to sandwich the third beam from above and below so as to move in the width direction along the third beam.

4. The vehicle stand according to claim 1, wherein
among the first support portion, the second support portion, the third support portion, and the fourth support portion, each of the support portions that move in the width direction includes a side plate that contacts a wheel so as to move in the width direction when the side plate is pushed by the wheel.
